(19) United States
(12) Patent Application Publication
(10) Pub. No.: US 2003/0167824 A1
(43) Pub. Date: Sep. 11, 2003

(54) Density measurements of aerated liquids and slurries

(76) Inventors: Peter Arthur Brown, Peterborough (GB); Anthony John Prange, Peterborough (GB)

Correspondence Address: Cooper & Dunham, 1185 Avenue of the Americas, New York, NY, 10036, US

(21) Appl. No.: 10/297,242

(22) PCT Filed: Jun. 6, 2001
(86) PCT No.: PCT/GB01/02494

(30) Foreign Application Priority Data
Jun. 6, 2000 (GB) 0013597.0

(51) Int. Cl. G01N 9/00

(52) U.S. Cl. 73/32 A

(57) ABSTRACT

A method of measuring the density of an aerated liquid in a flowing supply of aerated liquid comprises passing sound vibrations through a portion (9) of the liquid supply and utilising the velocity of the sound through that liquid supply portion as a measure of the density, the pressure of that liquid supply portion being controlled (by 10; 13). A flow line (2) of aerated liquid is provided with a branch connection (3) to a branch line (9, 5, 7) which includes a through-flow density meter (4), a pressure transducer (8) being connected to the branch line for measuring the pressure in the branch line.

The present invention relates to the aeration or gasification of liquids and slurries, and in particular to the measurement of the density of such materials.

Many processes involve injection (and dispersion) of gas (or gases) into a liquid or slurry. Such processes are well known, but control of density after aeration (or gasification) is difficult as the common devices used for in-line density measurement have serious limitations and are unreliable on gasified materials.

Generally, control is carried out by monitoring the liquid flow and controlling the gas flow proportionally. This method, however, has a serious limitation as invariably some gas escapes from the liquid and the proportion changes with parameters such as temperature, viscosity, bubble size etc, so the actual density of the processed material may vary.

In our patent specification no. WO 00/64269 we have described processes for producing aerated confectionery coatings in which the rate of injection of gas into the confectionery material is controlled in response to a measure of the density of confectionery material in a supply to a coating head. We proposed the use of density measurement devices of the vibrating tube type, for example units available from PAAR Scientific Limited under designation DPR Density meter, and the possible use of a colour meter or of a viscometer.

In our patent specification no. WO 01/30174 we have described processes for maintaining an aerated supply of confectionery material for use with various confectionery products, the aerator being included in a recirculation circuit, and the aerator being controlled by a density measurement.

The present invention stems from further work on such processes and our discovery that it is possible, with potential advantage, to use a sonic velocity type density meter to measure the density of an aerated liquid or slurry provided that a radical reinterpretation of the meter output is employed in conjunction with pressure control of the aerated material.

The term ‘aerated’ will be used hereafter to include gasification with any gas, where the gas is present in bubble form, that is, not substantially dissolved in the liquid. The term ‘liquid’ will be used hereafter to include a slurry.

According to one aspect of the invention a method of measuring the density of an aerated liquid in a flowing supply of aerated liquid comprises passing sound vibrations through a portion of said liquid supply and utilising the velocity of the sound through said liquid supply portion as a measure of the density, the pressure of said liquid supply portion being controlled.

The pressure in said liquid supply portion is preferably controlled by adjusting a variable restriction applied to the supply portion downstream of the point at which density measurements are made.

Alternatively the pressure in said liquid supply portion is controlled by adjusting the rate of flow of the supply.

A second aspect of the invention comprises a method of controlling the aeration of a liquid confectionery material by controlling the rate of injection of gas into the confectionery material in response to a measure of the density of confectionery material, the density being measured by the method of the first aspect of the invention.

According to a third aspect of the invention we provide apparatus for measuring the density of an aerated liquid flowing, in use, in a flow line of aerated liquid confectionery material, the apparatus comprising a confectionery material branch connection adapted to be connected to the flow line, the branch connection being connected to a confectionery material branch line which includes a through-flow density meter and which is suitable for conveying a portion of an aerated liquid confectionery supply, a pressure transducer connected to the branch line for measuring the pressure in the branch line, and control means adapted to respond in use to the output of the density meter to adjust the pressure in the branch line in response to the output of the pressure transducer.

Thus, one embodiment of the invention can be considered to be an adaption of an existing type of sonic velocity density meter, principally involving control of pressure within the instrument in order to achieve usable, repeatable measurements of density on gasified materials, in an in-line mode.

Preferably the density meter is a PAAR™ sonic velocity density meter.

The confectionery material flow line is preferably provided with a flow restrictor of pre-determined dimensions positioned downstream of the branch connection.

In one embodiment the control means comprises an adjustable restrictor valve connected into the branch line downstream of the density meter.

In another embodiment the control means comprises a pump speed controller adapted to vary the speed of a pump positioned in the flow line upstream of the branch connection.

Preferably the apparatus further comprises a density measurement output for connection to a gasification control unit.

Two density monitoring systems for aerated supplies of liquid and in accordance with the invention will now be described, by way of example only, with reference to the accompanying schematic drawings in which:

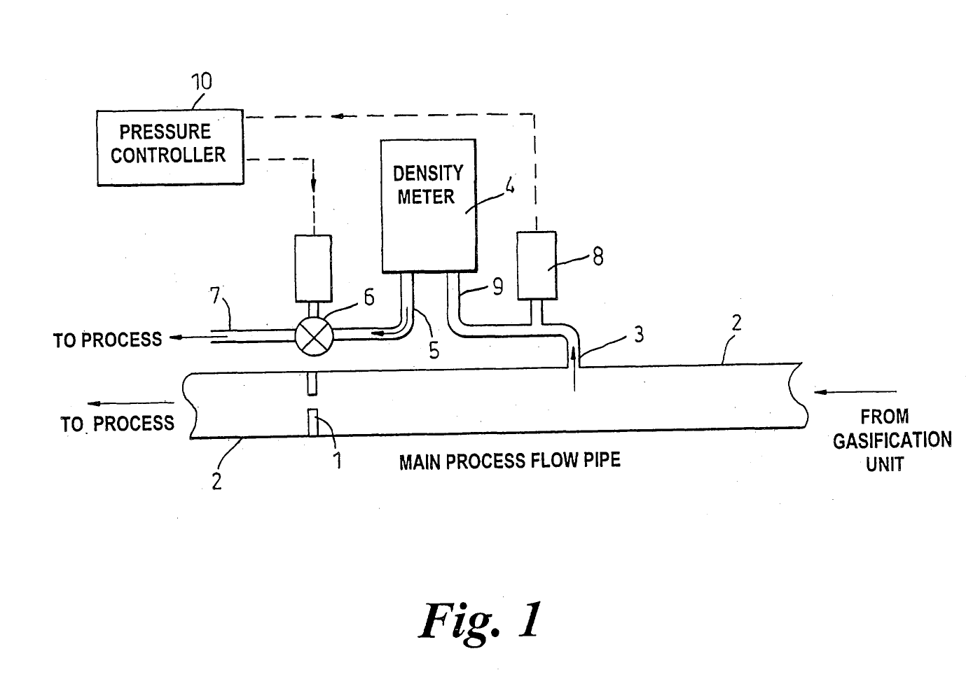

FIG. 1 is a schematic flow diagram of a first density monitoring system in accordance with the invention applied to a main process flow pipe leading from a gasification unit;

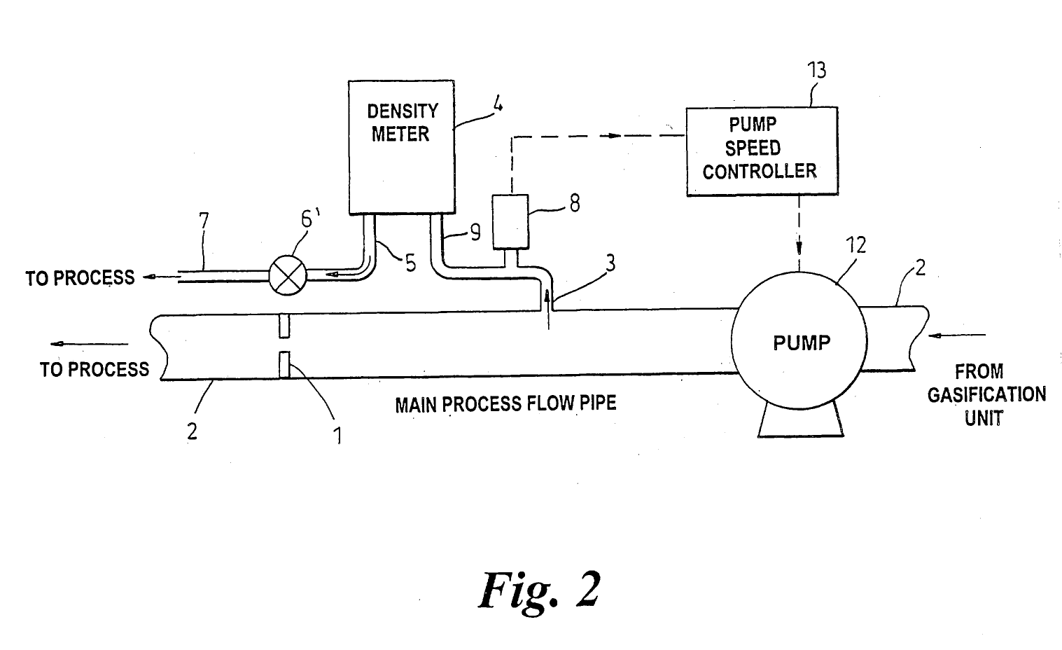

FIG. 2 is a similar flow diagram of a second density monitoring system in accordance with the invention; and

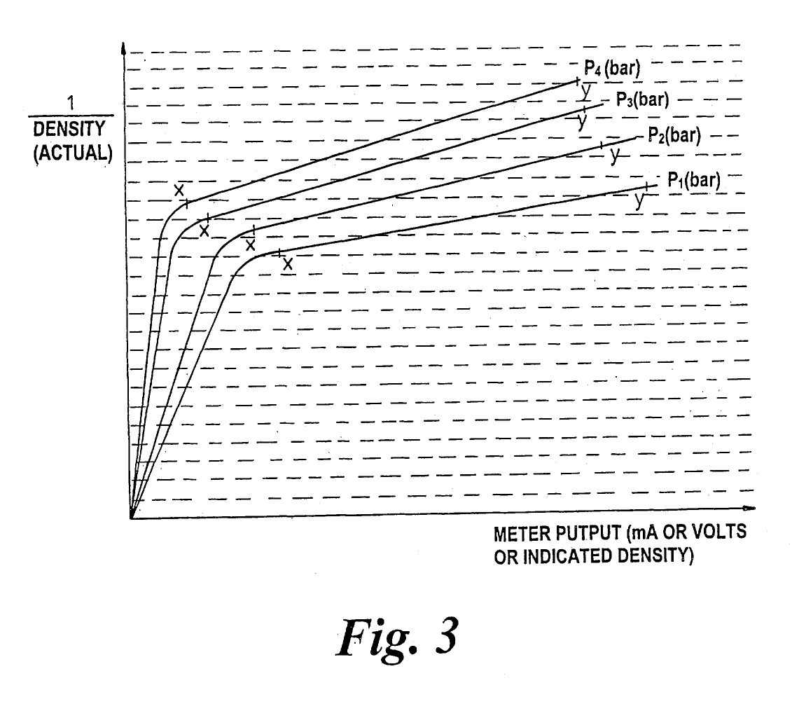

FIG. 3 is a graph of the response characteristics of a sonic velocity measuring device at different fluid pressures.

With reference to FIG. 3, we have surprisingly found that at constant pressure using a PAAR Scientific sonic velocity type density meter, the reciprocal of the actual density of the aerated liquid is proportional to the meter-indicated density over a usable range of the meter output, indicated as the range x-y for the pressure P₁. Each plot of FIG. 3 represents a series of meter outputs, when the meter is supplied with decreasing density gasified material (P₁<P₂<P₃<P₄).

It is seen from the plots of FIG. 3 that a straight-line relationship exists over the range x-y, and that the slope of the straight-line relationship between inverse actual density and indicated density over the usable range x-y increases with increasing pressure.

We have realised that by controlling the pressure of the fluid in that portion of the supply which passes through the sonic density meter, it becomes possible to use the output of the sonic density meter as a measure of the density of the aerated liquid, and this measurement of density can then be used as the basis for controlling a gasification unit, to achieve a desired density for the gasified liquid.

In the arrangement of FIG. 1, an orifice plate 1 has been positioned in a main supply pipe 2 from a gasification unit to a process for utilising the gasified liquid, the orifice plate providing a suitable working pressure for a density meter 4. The supply from the gasification unit is arranged to be substantially constant. A portion of the supply is tapped off in a branch pipe 3 upstream of the orifice plate 1 and is fed through the density meter 4 which is a PAAR sonic velocity density meter. The outlet 5 from the density meter 4 passes through an adjustable restrictor valve 6 and then continues at 7 to process. Thus, pipes 9, 5 and 7 constitute a branch line through which flows a portion of the supply to the process.

A pressure transducer 8 is arranged to provide a pressure signal, to a pressure controller 10 of conventional electronic or pneumatic type, which is a measure of the pressure in inlet 9 to the density meter 4. The pressure controller 10 utilises the output of pressure transducer 8 in well known manner to adjust restrictor valve 6 to control the pressure in outlet 5, and thus the pressure in density meter 4, to a predetermined pressure, thereby to enable the output of the density meter 4 to be used in conjunction with the output of pressure transducer 8 to determine, using the characteristics of the graph of FIG. 3, the actual density of the gasified liquid tapped off from the main supply 2.

In the modified arrangement of FIG. 2, parts corresponding to those of the system of FIG. 1 have been given corresponding reference numbers. In the modified arrangement the speed of a pump 12 providing the main flow through pipe 2 is controlled by a pump speed controller 13 in response to the output of the pressure transducer 8 in order to control the pressure of the gasified liquid supplied to density meter 4.

An adjustable restrictor valve 6′ in FIG. 2 is employed to provide an adjustment for the flow through density meter 4 so as to enable the density meter to be operating in the portion x-y of the characteristic of FIG. 3.

Although the pressure transducer 8 has been shown upstream of the density meter 4 in FIGS. 1 and 2, it is generally possible to place the pressure transducer downstream of the density meter if desired.

The arrangements of FIGS. 1 and 2 are particularly suitable for controlling the gasification of chocolate for use with confectionery, but they may be used to gasify other types of liquids.

It should be appreciated that the arrangements of FIGS. 1 and 2 may be applied to aeration of material flowing in a recirculation circuit, such as the recirculation circuits shown in specification no. WO 01/30174.

1. A method of measuring the density of an aerated liquid confectionery material in a flowing supply of aerated liquid confectionery material comprising passing sound vibrations through a portion of said liquid supply and utilising the velocity of the sound through said liquid supply portion as a measure of the density, the pressure of said liquid supply portion being controlled.

2. A method as claimed in claim 1 in which the pressure in said liquid supply portion is controlled by adjusting a variable restriction applied to the supply portion downstream of the point at which density measurements are made.

3. A method as claimed in claim 1 in which the pressure in said liquid supply portion is controlled by adjusting the rate of flow of the supply.

4. A method as claimed in any one of claims 1 to 3 in which the liquid confectionery material is chocolate.

5. A method as claimed in any of the preceding claims comprising using the measurement of density to control the rate of injection of gas into the confectionery material.

6. Apparatus for measuring the density of an aerated liquid confectionery material flowing, in use, in a flow line (2) of aerated liquid confectionery material, the apparatus comprising a confectionery material branch connection (3) adapted to be connected to the flow line, the branch connection being connected to a confectionery material branch line (9, 5, 7) which includes a through-flow density meter (4), and which is suitable for conveying a portion of an aerated liquid confectionery supply a pressure transducer (8) connected to the branch line for measuring the pressure in the branch line, and control means (10, 6; 13, 12) adapted to respond in use to the output of the density meter to adjust the pressure in the branch line in response to the output of the pressure transducer.

7. Apparatus as claimed in claim 6 assembled on a confectionery material flow line, the flow line being provided with a flow restrictor (1) of pre-determined dimensions positioned downstream of the branch connection.

8. Apparatus as claimed in claim 6 or claim 7 in which the control means comprises an adjustable restrictor valve 6 connected into the branch line downstream of the density meter.

9. Apparatus as claimed in claim 6 or claim 7 in which the control means comprises a pump speed controller (13) adapted to vary the speed of a pump (12) positioned in the flow line upstream of the branch connection (3).

10. Apparatus as claimed in any one of claims 6 to 9 comprising a density measurement output for connection to a gasification control unit.

11. Apparatus as claimed in any one of claims 6 to 9 suitable for use with aerated liquid chocolate.
